(19) United States
(12) Patent Application Publication
(10) Pub. No.: US 2016/0253137 A1
(43) Pub. Date: Sep. 1, 2016

(54) IMAGE PROCESSING APPARATUS PRESENTATION METHOD, IMAGE PROCESSING APPARATUS, AND IMAGE PROCESSING SYSTEM

(71) Applicant: KYOCERA Document Solutions Inc., Osaka (JP)

(72) Inventor: Yukihiro Nakao, Osaka (JP)

(21) Appl. No.: 15/051,588

(22) Filed: Feb. 23, 2016

(30) Foreign Application Priority Data
Feb. 26, 2015 (JP) 2015-036802

(51) Int. Cl. G06F 3/12; H04N 1/00

(52) U.S. Cl. CPC G06F 3/1238; H04N 1/00411; G06F 3/1222; G06F 3/1236; G06F 3/126; G06F 3/1292; G06F 3/1284; H04N 2201/0094

(57) ABSTRACT

A first information processing apparatus selects an apparatus-to-be-used from among a plurality of image processing apparatuses that are communicable through a first communication line, and receives terminal identification information which identifies a second information processing apparatus carried by a user, from the second information processing apparatus through a wireless second communication line. The first information processing apparatus transmits location presentation information to the second information processing apparatus, and transmits the terminal identification information to the apparatus-to-be-used. The image processing apparatus executes a process of guiding the user to the image processing apparatus when the terminal identification information received from the first information processing apparatus and the terminal identification information received from the second information processing apparatus match each other.

### INCORPORATION BY REFERENCE

This application is based upon and claims the benefit of priority from the corresponding Japanese Patent Application No. 2015-036802 filed on Feb. 26, 2015, the entire contents of which are incorporated herein by reference.

### BACKGROUND

The present disclosure relates to image processing apparatus presentation methods, image processing apparatuses, and image processing systems.

Image processing apparatuses that can execute image processing jobs such as a printing job and a document sheet scanning job are generally known. Such an image processing apparatus is, for example, an image forming apparatus that can execute a printing job of forming an image on a sheet material, an image reading apparatus that can execute a document sheet scanning job of reading an image from a document sheet, or the like.

It is also known that an image forming apparatus provided with a plurality of sheet discharge bins displays user information on a display portion of a sheet discharge bin that corresponds to a user who is the transmission source of a printing job.

### SUMMARY

An image processing apparatus presentation method according to one aspect of the present disclosure includes the following process. The method includes a first information processing apparatus selecting an apparatus-to-be-used from among a plurality of image processing apparatuses that are communicable through a first communication line. Further, the method includes the first information processing apparatus receiving terminal identification information which identifies a second information processing apparatus carried by a user, from the second information processing apparatus through a wireless second communication line. Further, the method includes the first information processing apparatus transmitting location presentation information regarding presentation of a location of the apparatus-to-be-used, to the second information processing apparatus through the second communication line. Further, the method includes the first information processing apparatus transmitting the terminal identification information to the apparatus-to-be-used through the first communication line, and the apparatus-to-be-used receiving the terminal identification information from the first information processing apparatus. Further, the method includes an image processing apparatus receiving the terminal identification information from the second information processing apparatus through the second communication line. Further, the method includes the image processing apparatus determining whether a user-in-proximity state has been established where the terminal identification information received from the first information processing apparatus and the terminal identification information received from the second information processing apparatus match each other. Further, the method includes the image processing apparatus executing a guiding process of guiding the user to the image processing apparatus when the user-in-proximity state has been established.

An image processing apparatus according to another aspect of the present disclosure includes a first communication portion, a second communication portion, a job execution portion, a terminal information indirect reception portion, an output-side terminal information direct reception portion, an information matching determination portion, and a user guiding potion. The first communication portion is communicable with a first information processing apparatus through a first communication line. The second communication portion is communicable with a second information processing apparatus carried by a user, through a wireless second communication line. The job execution portion executes an image processing job. The image processing job includes a printing job of forming an image on a sheet material or a document sheet scanning job of reading an image from a document sheet. The terminal information indirect reception portion receives terminal identification information which identifies the second information processing apparatus, from the first information processing apparatus through the first communication line. The output-side terminal information direct reception portion receives the terminal identification information from the second information processing apparatus through the second communication line. The information matching determination portion determines whether a user-in-proximity state has been established where the terminal identification information received from the first information processing apparatus and the terminal identification information received from the second information processing apparatus match each other. The user guiding potion executes a guiding process of guiding the user to the image processing apparatus when the user-in-proximity state has been established.

An image processing system according to another aspect of the present disclosure includes a plurality of the image processing apparatuses according to the other aspect of the present disclosure, and a first information processing apparatus communicable with each of the image processing apparatuses through a first communication line. The first information processing apparatus includes an apparatus-to-be-used selection portion, an input-side terminal information direct reception portion, a location presentation information transmission portion, and a terminal information transmission portion. The apparatus-to-be-used selection portion selects an apparatus-to-be-used from among the plurality of the image processing apparatuses. The input-side terminal information direct reception portion receives terminal identification information which identifies a second information processing apparatus carried by a user, from the second information processing apparatus through a wireless second communication line. The location presentation information transmission portion transmits location presentation information regarding presentation of a location of the apparatus-to-be-used, to the second information processing apparatus through the second communication line. The terminal information transmission portion transmits the terminal identification information to the apparatus-to-be-used through the first communication line.

According to the present disclosure, it is possible to provide an image processing apparatus presentation method, an image processing apparatus, and an image processing system that can, in an environment where a user does not know the location and the function of each of a plurality of image processing apparatuses in a LAN, appropriately guide the user to an image processing apparatus that executes an image processing job requested by the user.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an image forming system according to an embodiment.

FIG. 2 is a block diagram of an image processing apparatus in the image forming system according to the embodiment.

FIG. 3 is a block diagram of a reception apparatus in the image forming system according to the embodiment.

FIG. 4 is a flow chart showing one example of the procedure of an apparatus-to-be-used presentation process executed by the reception apparatus in the image forming system according to the embodiment.

FIG. 5 is a flow chart showing one example of the procedure of an apparatus-use requesting process executed by a mobile terminal in communication with the image forming system according to the embodiment.

FIG. 6 is a flow chart showing one example of the procedure of a job preparation process executed by the image processing apparatus in the image forming system according to the embodiment.

FIG. 7 is a flow chart showing one example of the procedure of a guide/job control executed by the image processing apparatus in the image forming system according to the embodiment.

FIG. 8 is a flow chart showing one example of the procedure of the mobile-side presentation and guiding process executed by the mobile terminal in communication with the image forming system according to the embodiment.

FIG. 9 shows one example of a route presentation screen to be displayed on the mobile terminal in communication with the image forming system according to the embodiment.

FIG. 10 shows one example of a guiding screen to be displayed on the mobile terminal in communication with the image forming system according to the embodiment.

### DETAILED DESCRIPTION

Hereinafter, embodiments of the present disclosure will be described with reference to the accompanying drawings. It should be noted that the following embodiments are examples embodying the present disclosure, and by nature, do not limit the technical scope of the present disclosure.

[Configuration of Image Processing System 100]

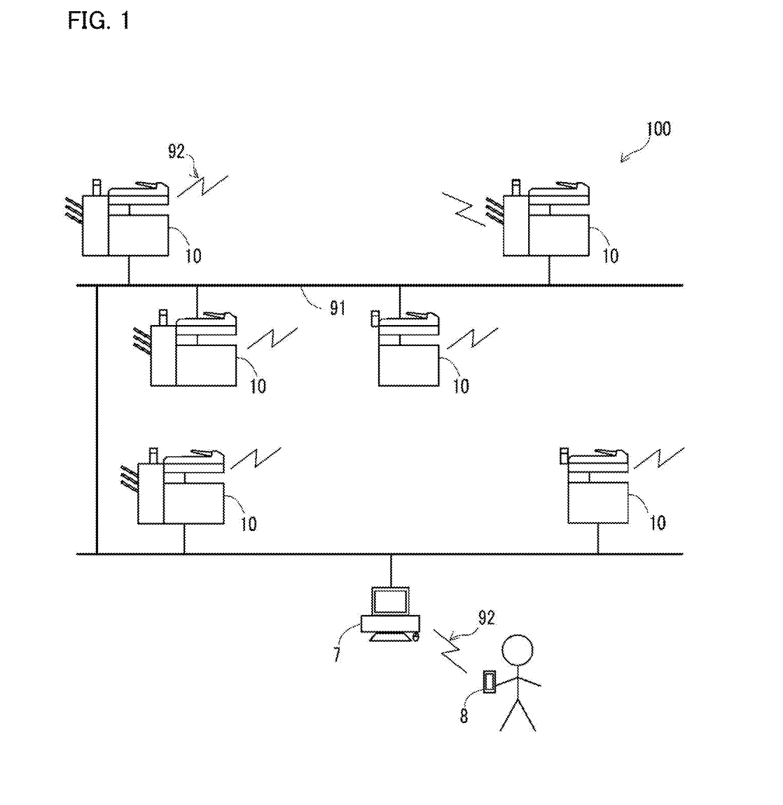

First, with reference to FIG. 1, a configuration of an image processing system 100 according to an embodiment will be described. The image processing system 100 includes a reception apparatus 7 and a plurality of image processing apparatuses 10.

The image processing system 100 has a function of guiding a user to an image processing apparatus 10 to be used by the user among the plurality of image processing apparatuses 10.

The reception apparatus 7 is an information processing apparatus such as a personal computer. The reception apparatus 7 is communicable with each of the plurality of image processing apparatuses 10 through a first communication line 91. For example, it is conceivable that the first communication line 91 is a wired LAN, a wireless LAN, or a combination thereof.

Each image processing apparatus 10 is an apparatus that executes image processing jobs. The image processing jobs are a printing job and a document sheet scanning job, for example. The printing job is a process of forming an image on a sheet material. The document sheet scanning job is a process of reading an image from a document sheet.

The printing job includes a received data printing job whose printing target is data obtained from another apparatus through the first communication line 91, and a copying job whose printing target is image data obtained through the document sheet scanning job.

Each image processing apparatus 10 in the present embodiment is a multifunction peripheral which serves as an image forming apparatus capable of executing the printing job and which also serves as an image reading apparatus capable of executing the document sheet scanning job.

The image processing system 100 includes image processing apparatuses 10 that have different image processing functions. The differences in the image processing functions can be, for example, difference in output image resolution, difference in image reading resolution, the presence/absence of a color image forming function, the presence/absence of a both-side image forming function, the presence/absence of a color image reading function, the presence/absence of a both-side image reading function, the presence/absence of a facsimile communication function, and the presence/absence or the type of a post-processing function. The difference in the post-processing function can be the presence/absence of a printed matter sorting function, the presence/absence of a stapling function, the presence/absence of a punch hole forming function, and the like.

The color image forming function, the both-side image forming function, the color image reading function, and the both-side image reading function encompass a monochrome image forming function, a one-side image forming function, a monochrome image reading function, and a one-side image reading function, respectively.

The reception apparatus 7 and each image processing apparatus 10 are communicable with a mobile terminal 8 carried by a user, through a wireless second communication line 92. For example, the mobile terminal 8 is a smartphone, a tablet computer, a wearable computer, or the like. The wearable computer is a glasses-type computer or another type computer, for example.

The second communication line 92 is a wireless communication line open to an apparatus that is not permitted to be connected to the first communication line 91. For example, it is conceivable that the second communication line 92 is a wireless communication line whose communicable range is smaller than that of the first communication line 91. More specifically, it is conceivable that the second communication line 92 is a wireless communication line such as well-known Bluetooth (registered trademark) or Wifi.

It should be noted that the reception apparatus 7 is one example of a first information processing apparatus, and the mobile terminal 8 is one example of a second information processing apparatus.

[Configuration of Image Processing Apparatus 10]

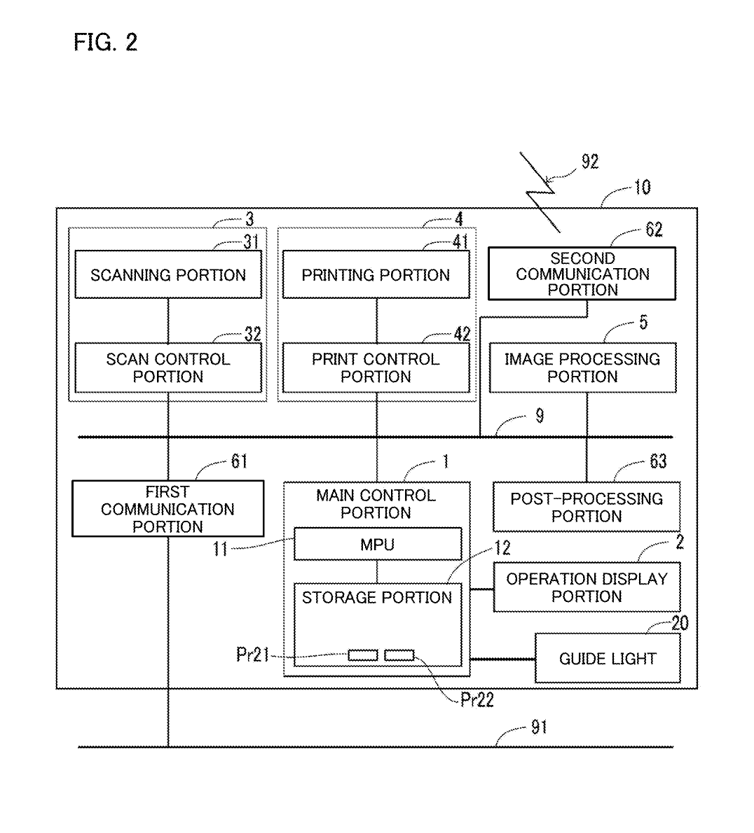

Next, with reference to FIG. 2, a configuration of the image processing apparatus 10 will be described. The image processing apparatus 10 includes a main control portion 1, an operation display portion 2, a document sheet scanning job processing portion 3, a printing job processing portion 4, an image processing portion 5, a first communication portion 61, a second communication portion 62, and the like.

The document sheet scanning job processing portion 3 includes a scanning portion 31 and a scan control portion 32. The printing job processing portion 4 includes a printing portion 41 and a print control portion 42.

Among the plurality of image processing apparatuses 10, there also is an image processing apparatus 10 that is provided with a post-processing portion 63 which realizes the post-processing function. In addition, each image processing apparatus 10 in the present embodiment is provided with a guide light 20. The guide light 20 is an indicator light which is turned on in order to make an image processing apparatus 10 noticeable and which is turned OFF in other cases. It should be noted that the guide light 20 is one example of a notification portion.

The main control portion 1, the scan control portion 32, the print control portion 42, the image processing portion 5, the first communication portion 61, the second communication portion 62, and the post-processing portion 63 are each connected to a bus 9, and can exchange data with one another through the bus 9.

The scanning portion 31 includes: an optical system not shown which scans a document sheet with light; an image sensor not shown which detects, for each pixel, the amount of light reflected from the document sheet and which outputs document sheet image data; and the like.

The scan control portion 32 controls the scanning portion 31 and obtains the document sheet image data. Further, the scan control portion 32 transfers, through the bus 9, the document sheet image data to other devices such as the image processing portion 5. That is, the document sheet scanning job processing portion 3 executes a document sheet scanning job of reading an image from the document sheet.

The printing portion 41 forms an image on an image recording medium through image forming processing according to well-known electrophotography. The printing portion 41 includes an image carrier not shown and peripheral devices therefor, transfers an image of a developer from the image carrier to the image recording medium, and fixes the image on the image recording medium.

The print control portion 42 obtains printing image data from the image processing portion 5, and causes the printing portion 41 to execute a printing process of forming an image based on the printing image data, onto a sheet material. That is, the printing job processing portion 4 executes a printing job of forming, on the sheet material, the image represented by the printing image data. The document sheet scanning job processing portion 3 and the printing job processing portion 4 are examples of a job execution portion.

The first communication portion 61 transmits/receives data to/from an external apparatus such as the reception apparatus 7 or another image processing apparatus 10. Further, the first communication portion 61 exchanges data with other devices through the bus 9. For example, the first communication portion 61 receives printing job data for image forming from the external apparatus and transfers the printing job data to the image processing portion 5 through the bus 9.

The first communication portion 61 also has a function of obtaining the document sheet image data from the scan control portion 32 via the image processing portion 5 and of transmitting data including the document sheet image data to the external apparatus.

The second communication portion 62 transmits/receives data to/from the mobile terminal 8 of the user through the second communication line 92. Further, the second communication portion 62 exchanges data with other devices such as the main control portion 1 through the bus 9.

In processes in which the image processing apparatus 10 transmits/receives data to/from the reception apparatus 7 through the first communication line 91, the first communication portion 61 relays the data communication between the main control portion 1 and the reception apparatus 7. Similarly, in processes in which the image processing apparatus 10 transmits/receives data to/from the mobile terminal 8 through the second communication line 92, the second communication portion 62 relays the data communication between the main control portion 1 and the mobile terminal 8.

The image processing portion 5 executes various types of data processing onto image data and the like obtained from other devices through the bus 9. The target of data processing performed by the image processing portion 5 is, for example, the document sheet image data obtained from the scan control portion 32, the printing job data obtained from the external apparatus through the first communication portion 61, or the like.

For example, the image processing portion 5 performs image processing such as image rotation processing, halftone processing, or size cut processing, onto the document sheet image data obtained from the scan control portion 32. The image processing portion 5 also executes, among others, a process of converting, into printing image data, the document sheet image data obtained from the scan control portion 32 and the printing job data obtained from the first communication portion 61, and of transferring the printing image data to the print control portion 42.

The operation display portion 2 includes: an information inputting operation portion that includes a touch panel, operation buttons, and the like; and a display portion that includes a liquid crystal display panel and a notification lamp, and the like, for example.

The main control portion 1 performs comprehensive control over other control portions. For example, the main control portion 1 causes the operation display portion 2 to display an operation menu and the like. Further, the main control portion 1 outputs control commands to other control portions in accordance with detection results from various types of sensors and in accordance with input information inputted through operation performed on the operation display portion 2. As shown in FIG. 2, the main control portion 1 includes an MPU (Micro Processor Unit) 11, a storage portion 12, and the like.

The MPU 11 is a processor which executes various types of calculation and data processing. The storage portion 12 is a non-volatile computer-readable memory in which various types of information referred to by the MPU 11 are stored. The storage portion 12 is also a memory from/into which the MPU 11 can read/write various types of information.

In the storage portion 12, programs for causing the MPU 11 to execute various types of processes, information referred to by the MPU 11 executing the programs, and information written by the MPU 11 executing the programs are stored. The main control portion 1 also includes a volatile storage portion not shown, such as a RAM, in which programs executed by the MPU 11 are temporarily stored.

[Configuration of Reception Apparatus 7]

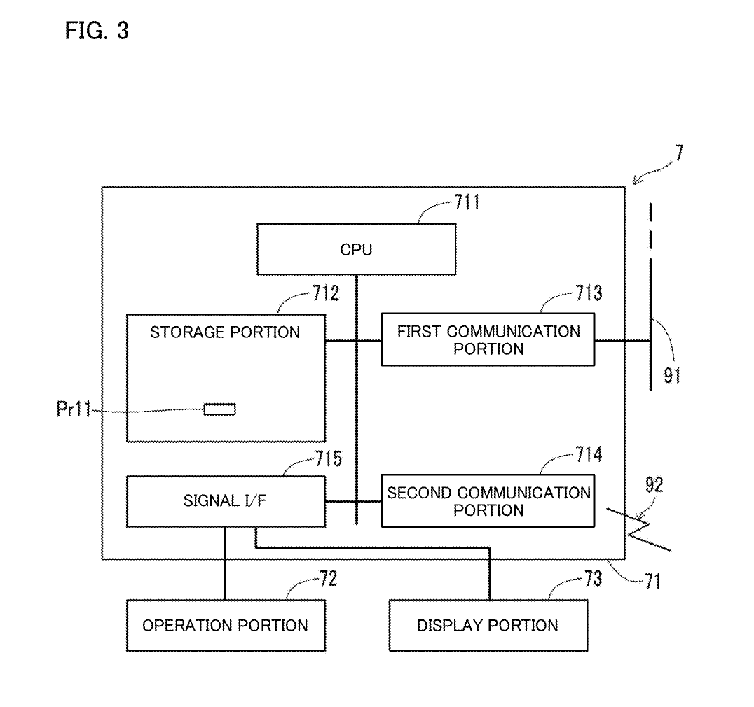

As shown in FIG. 3, the reception apparatus 7 includes a body portion 71, an operation portion 72, and a display portion 73. The body portion 71 includes a CPU (Central Processing Unit) 711, a storage portion 712, a first communication portion 713, a second communication portion 714, a signal interface 715, and the like.

The CPU 711 is a processor which executes various types of calculation and data processing. The storage portion 712 is a non-volatile storage portion in which various types of information referred to by the CPU 711 are stored. The storage portion 712 is also a storage portion from/into which the CPU 711 can read/write various types of information.

In the storage portion 712, programs for causing the CPU 711 to execute various types of processes and information referred to by the CPU 711 executing the programs, and information written by the CPU 711 executing the programs are stored. The body portion 71 also includes a volatile storage portion not shown, such as a RAM, in which programs executed by the CPU 711 are temporarily stored.

The operation portion 72 is an information inputting device such as a keyboard or a mouse that inputs information in accordance with operation performed by a person. The display portion 73 is an information outputting device such as a liquid crystal display. The signal interface 715 relays the exchange of information between the CPU 711, and the operation portion 72 and the display portion 73.

Similarly to the first communication portion 61 of each image processing apparatus 10, the first communication portion 713 transmits/receives data to/from an external apparatus such as an image processing apparatus 10 through the first communication line 91. Further, the first communication portion 61 exchanges data with the CPU 711.

Similarly to the second communication portion 62 of each image processing apparatus 10, the second communication portion 714 transmits/receives data to/from the mobile terminal 8 of the user through the second communication line 92. Further, the second communication portion 714 exchanges data with the CPU 711.

In processes in which the reception apparatus 7 transmits/receives data to/from the image processing apparatus 10 through the first communication line 91, the first communication portion 713 relays the data communication between the CPU 711 and the image processing apparatus 10. Similarly, in processes in which the reception apparatus 7 transmits/receives data to/from the mobile terminal 8 through the second communication line 92, the second communication portion 714 relays the data communication between the CPU 711 and the mobile terminal 8.

Meanwhile, in an environment where the user does not know the location and the function of each of the plurality of image processing apparatuses 10 connected to the first communication line 91, there are cases where the user wishes to use an image processing apparatus 10. For example, a use environment is conceivable in which the user wishes to use an image processing apparatus 10 installed in a facility such as a library which is not related to the section where the user belongs.

In such a use environment, it is desired to appropriately guide the user to an image processing apparatus 10 that can execute the image processing job requested by the user.

The image processing system 100 has a function of, in an environment where the user does not know the location and the like of each of the plurality of image processing apparatuses 10 connected to the first communication line 91, appropriately guiding the user to an image processing apparatus 10 that can execute the job requested by the user.

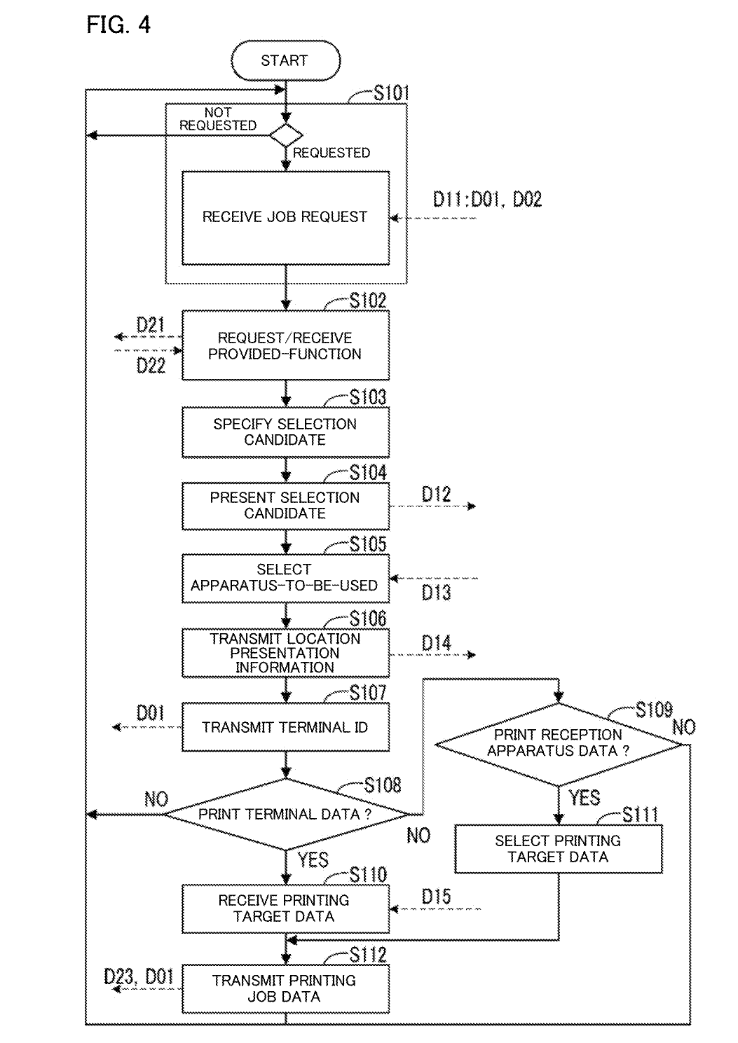

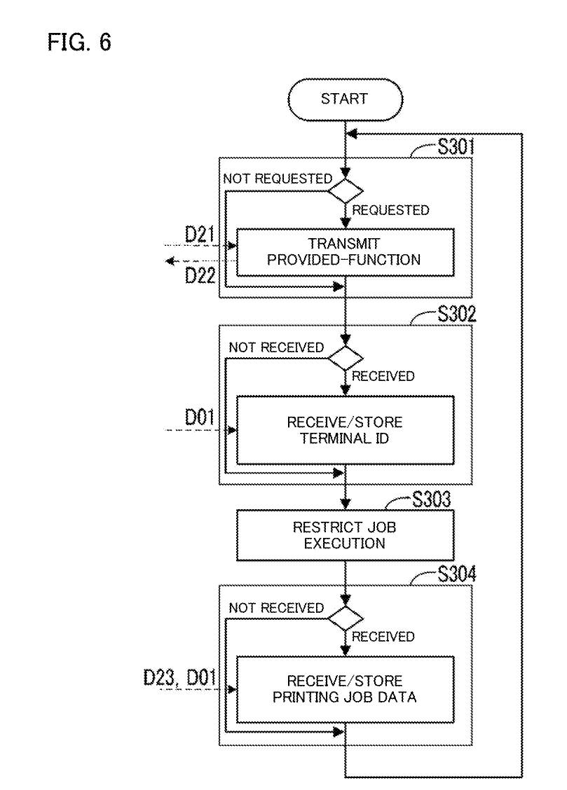

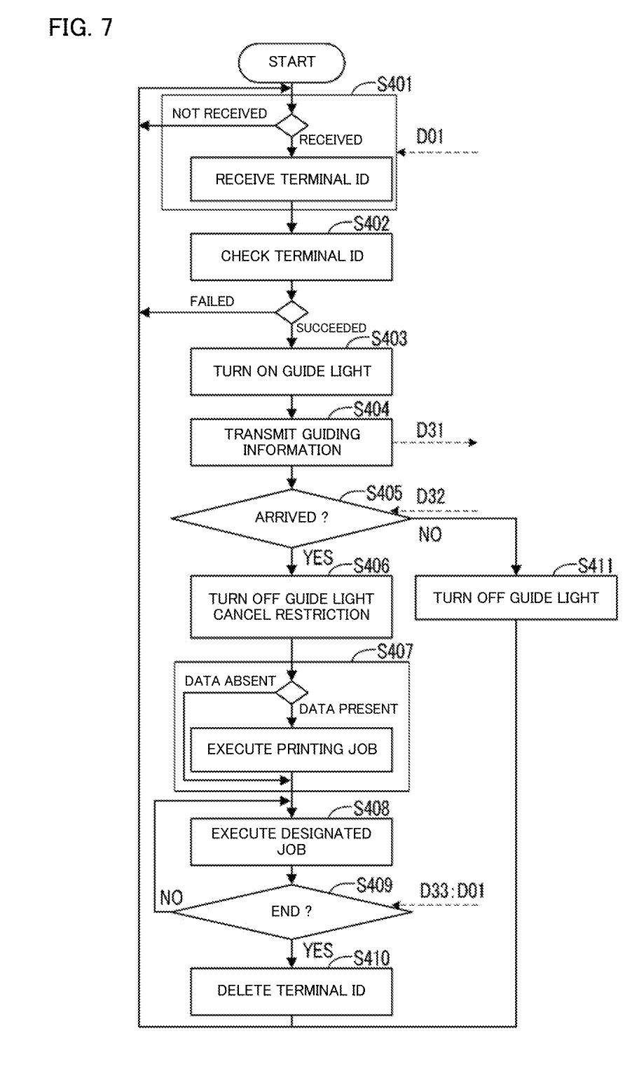

In the image processing system 100, in order to appropriately guide the user, the reception apparatus 7 executes an apparatus-to-be-used presentation process shown in FIG. 4, and the image processing apparatus 10 executes a job preparation process shown in FIG. 6 and a guide/job control shown in FIG. 7.

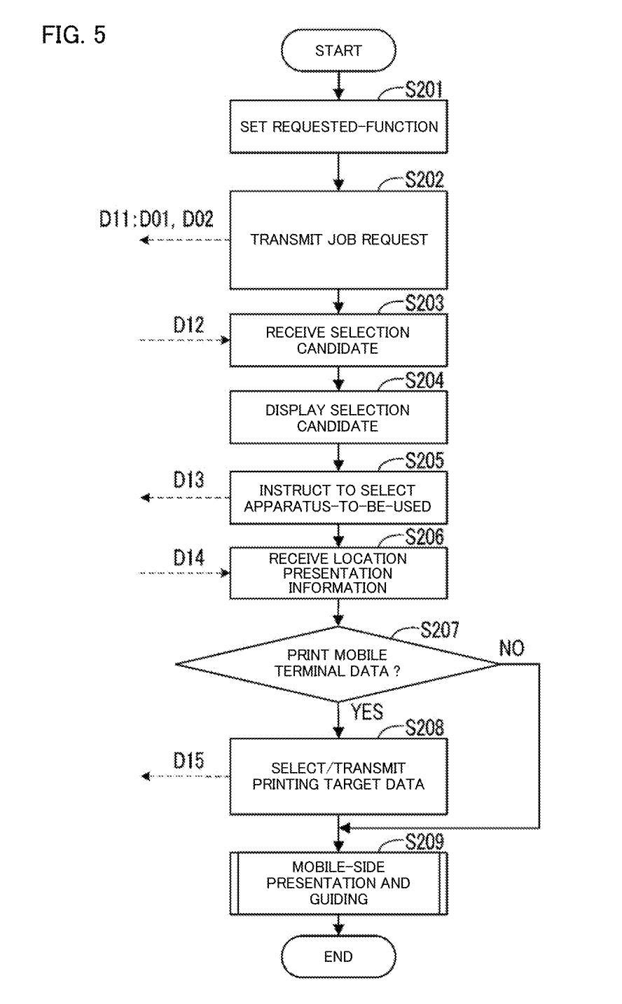

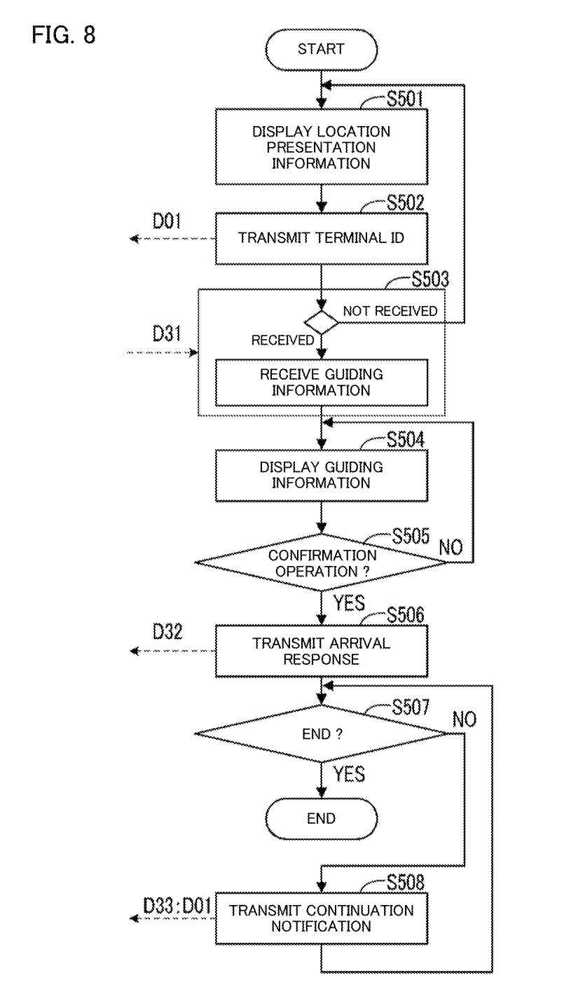

Meanwhile, the mobile terminal 8 carried by the user executes an apparatus-use requesting process shown in FIG. 5 and a mobile-side presentation and guiding process shown in FIG. 8. The apparatus-use requesting process is a process that involves communication with the reception apparatus 7 which executes the apparatus-to-be-used presentation process. The mobile-side presentation and guiding process is a process that involves communication with the image processing apparatus 10 that executes the guide/job control.

[Apparatus-to-be-Used Presentation Process]

Hereinafter, with reference to the flow chart shown in FIG. 4, one example of the procedure of the apparatus-to-be-used presentation process executed by the reception apparatus 7 will be described. In the following description, S101, S102, . . . each represents an identification character of its corresponding step executed by the reception apparatus 7.

By the CPU 711 of the reception apparatus 7 executing an apparatus-to-be-used presentation program Pr11, the apparatus-to-be-used presentation process by the reception apparatus 7 is realized. The reception apparatus 7 starts the apparatus-to-be-used presentation process when, for example, having detected a predetermined start operation performed on the operation portion 72.

<Step S101>

In the apparatus-to-be-used presentation process, the reception apparatus 7 monitors whether a job request command D11 has arrived from the mobile terminal 8 of the user. When the job request command D11 has arrived, the reception apparatus 7 receives the job request command D11 from the mobile terminal 8 through the second communication line 92.

The job request command D11 includes a terminal ID (D01) being identification information of the mobile terminal 8, and requested-function information D02 regarding the image processing job. For example, it is conceivable that the terminal ID (D01) is the MAC address of the mobile terminal 8, the account information of the user set in advance in the mobile terminal 8, or the like.

The requested-function information D02 denotes the image processing function requested to be provided in an image processing apparatus 10 for execution of the image processing job. Hereinafter, the image processing function represented by the requested-function information D02 will be referred to as a requested-function.

Further, the job request command D11 includes data supply source information D03 indicating the supply source of the printing target in the case where the image processing job requested by the user is the printing job. For example, it is conceivable that the supply source of the printing target is the mobile terminal 8, the reception apparatus 7, or the like.

When the data supply source information D03 indicates the mobile terminal 8, data of the printing target is transmitted from the mobile terminal 8 to the reception apparatus 7, and further transferred to the image processing apparatus 10. When the data supply source information D03 indicates the reception apparatus 7, data of the printing target is transmitted from the storage portion 712 of the reception apparatus 7 to the image processing apparatus 10.

<Step S102>

Upon receiving the job request, the reception apparatus 7 transmits a provided-function request command D21 which requests provided-function information D22, to each of all image processing apparatuses 10 that are communicable through the first communication line 91.

Further, the reception apparatus 7 receives provided-function information D22 transmitted from each of the image processing apparatuses 10 in response to the provided-function request command D21.

The provided-function information D22 is information indicating the image processing function provided in its corresponding image processing apparatus 10. Hereinafter, the image processing function indicated by the provided-function information D22 will be referred to as a provided-function.

It is also conceivable that, in step S102, the reception apparatus 7 obtains, from each image processing apparatus 10 through the first communication line 91, location information of the image processing apparatus 10 in addition to the provided-function information D22. The location information is information that allows at least identification of the magnitude relationship of the route lengths from the reception apparatus 7 to the respective image processing apparatuses 10.

It is also conceivable that the location information of each image processing apparatus 10 is stored in advance in the storage portion 712 of the reception apparatus 7.

<Step S103>

Further, the reception apparatus 7 specifies the transmission sources of provided-function information D22 which indicates the provided-function encompassing the requested-function, as selection candidates D12 for the apparatus-to-be-used. The apparatus-to-be-used is the apparatus that executes the image processing job requested by the user.

<Step S104>

Next, the reception apparatus 7 executes a process of presenting the selection candidates D12 for the apparatus-to-be-used, to the user. In the present embodiment, the reception apparatus 7 presents the selection candidates D12 to the user, by transmitting information of the selection candidates D12 to the transmission source of the job request command D11 through the second communication line 92.

As described later, the mobile terminal 8 displays, on its display portion, the selection candidates D12 received from the reception apparatus 7. It is also conceivable that the reception apparatus 7 presents the selection candidates D12 to the user, by displaying the selection candidates D12 on its own display portion 73.

It is conceivable that, in step S104, the reception apparatus 7 presents selection candidates D12 that have shorter route lengths from the reception apparatus 7 specified by the location information, in preference to other selection candidates D12. As a method for such preference presentation of selection candidates D12, presenting selection candidates D12 in the above-described order, sorted by colors or highlighted, or along with the route length information is conceivable, for example.

It is also conceivable that, in step S104, the reception apparatus 7 presents information of each selection candidate D12 along with information of its provided-function.

<Step S105>

Next, the reception apparatus 7 receives an apparatus-to-be-used selection instruction command D13 from the mobile terminal 8, and selects the apparatus-to-be-used in accordance with the content of the apparatus-to-be-used selection instruction command D13. The apparatus-to-be-used selection instruction command D13 is a command that instructs to select, as the apparatus-to-be-used, one image processing apparatus 10 designated in the mobile terminal 8 from among the selection candidates D12 in accordance with the operation performed by the user.

It is also conceivable that the reception apparatus 7 automatically selects, as the apparatus-to-be-used, the image processing apparatus 10 that is installed at a location where the route length from the reception apparatus 7 is shortest, from among the selection candidates D12. It is also conceivable that the reception apparatus 7 selects the apparatus-to-be-used from among the selection candidates D12, in accordance with operation performed on its own operation portion 72. In this case, the user performs operation of selecting the apparatus-to-be-used, on the operation portion 72 of the reception apparatus 7.

<Step S106>

When the apparatus-to-be-used has been selected, the reception apparatus 7 transmits location presentation information D14 regarding presentation of the location of the apparatus-to-be-used, to the mobile terminal 8 through the second communication line 92.

For example, it is conceivable that the location presentation information D14 includes one or both of floor map information of the area encompassing the reception apparatus 7 and the apparatus-to-be-used, and travel route information indicating the travel route from the reception apparatus 7 to the apparatus-to-be-used. Moreover, it is conceivable that each kind of the above information is one or both of an image such as a figure or a picture, and explanatory text. Moreover, it is also conceivable that the location presentation information D14 includes: the floor map information or the travel route information; and azimuth information indicating the azimuth in the floor map information or in the travel route information.

If the mobile terminal 8 includes an electromagnetic compass, the mobile terminal 8 can display, on its own display portion, the azimuth detected by the electromagnetic compass and the azimuth indicated by the azimuth information.

<Step S107>

Further, the reception apparatus 7 transmits the terminal ID (D01) included in the job request command D11, to the apparatus-to-be-used through the first communication line 91. The apparatus-to-be-used can identify the mobile terminal 8 of the user that will use the apparatus-to-be-used, by means of the terminal ID (D01).

<Steps S108, S109>

The reception apparatus 7 determines the content of the data supply source information D03 included in the job request command D11. That is, the reception apparatus 7 executes determination of whether a printing job whose printing target is data in the mobile terminal 8 is requested (S108), and determination of whether a printing job whose printing target is data in the reception apparatus 7 is requested (S109).

When the requested job is a printing job whose printing target is neither the data in the mobile terminal 8 nor the data in the reception apparatus 7, the reception apparatus 7 repeats the processes from step S101 in order to receive a new image processing job.

<Step S110>

When the requested job is the printing job whose printing target is the data in the mobile terminal 8, the reception apparatus 7 receives printing target data D15 from the mobile terminal 8.

<Step S111>

When the requested job is the printing job whose printing target is the data in the reception apparatus 7, the reception apparatus 7 executes a process of selecting the data of the printing target. In this case, the data of the printing target is data already stored in the storage portion 712 of the reception apparatus 7, data that the reception apparatus 7 will download into its own storage portion 712 from another device through the first communication line 91, or the like.

In the process of selecting the printing target, the data of the printing target is selected in accordance with operation performed on the operation portion 72 of the reception apparatus 7, or in accordance with a selection command from the mobile terminal 8.

<Step S112>

The reception apparatus 7 generates printing job data D23 that corresponds to the printing target data D15 received in step S110 or the printing target selected in step S111, and transmits the printing job data D23 to the apparatus-to-be-used along with the terminal ID (D01). The printing job data D23 is data to be used in execution of the printing job.

The terminal ID (D01) transmitted along with the printing job data D23 is identification information of the transmission source of the printing target data D15. After step S112, the reception apparatus 7 repeats the processes from step S101 in order to receive a new image processing job.

[The Apparatus-Use Requesting Process]

Next, with reference to the flow chart shown in FIG. 5, one example of the procedure of the apparatus-use requesting process executed by the mobile terminal 8 will be described. In the following description, S201, S202, . . . each represents an identification character of its corresponding step executed by the mobile terminal 8.

The mobile terminal 8 includes a CPU and a storage portion not shown. In the mobile terminal 8, the CPU executes an apparatus-use request program stored in the storage portion. Accordingly, the apparatus-use requesting process by the mobile terminal 8 is realized. The mobile terminal 8 starts the apparatus-use requesting process when having detected a predetermined start operation performed on the operation portion of the mobile terminal 8, for example.

<Step S201>

In the apparatus-use requesting process, the mobile terminal 8 executes a process of setting the requested-function in accordance with operation performed by the user. In step S201, the data supply source information D03 is also set.

For example, it is conceivable that: a plurality of candidates for requested-functions are registered in advance in the storage portion of the mobile terminal 8; and a requested-function is selected from among the plurality of candidates in accordance with the operation performed by the user.

It is also conceivable that the mobile terminal 8 includes a camera, and a requested-function automatic setting function of setting a part or the entirety of the requested-function based on image data obtained by the camera. In this case, the image data is image data of a document sheet targeted by the printing job or by an image reading job.

For example, the requested-function automatic setting function includes a function of determining whether the image of the image data is a color image, and of setting, as the requested-function, the color image forming function in accordance with the result of the determination.

It is also conceivable that the requested-function automatic setting function includes a function of determining whether the image of the image data is a picture image and of setting, as the requested-function, the range of resolution to be used in image forming in accordance with the result of the determination.

It is also conceivable that the requested-function automatic setting function includes, among others, a function of extracting digital watermarking information included in the image data, and of setting, as the requested-function, the image processing function indicated by the digital watermarking information.

<Step S202>

Next, the mobile terminal 8 transmits a job request command D11 to the reception apparatus 7 through the second communication line 92. The job request command D11 includes a terminal ID (D01) which identifies the mobile terminal 8 itself, requested-function information D02 indicating the requested-function set in step S201, and the data supply source information D03 set in step S201.

<Step S203>

Next, the mobile terminal 8 receives selection candidates D12 for the apparatus-to-be-used from the reception apparatus 7 through the second communication line 92.

<Step S204>

As described above, the mobile terminal 8 displays, on its display portion, the selection candidates D12 received from the reception apparatus 7.

<Step S205>

The mobile terminal 8 determines a candidate to be designated as the apparatus-to-be-used from among the displayed selection candidates D12, in accordance with operation performed on the operation portion of the mobile terminal 8. Further, the mobile terminal 8 transmits an apparatus-to-be-used selection instruction command D13 indicating the result of the determination to the reception apparatus 7 through the second communication line 92.

<Step S206>

Next, the mobile terminal 8 receives location presentation information D14 regarding presentation of the location of the apparatus-to-be-used selected by the reception apparatus 7, from the reception apparatus 7 through the second communication line 92.

<Step S207>

The mobile terminal 8 performs control on whether to execute or skip the process of the next step S208, depending on whether the requested image processing job is a printing job whose printing target is data in the mobile terminal 8.

The data supply source information D03 of the job request command D11 set in step S201 indicates whether the data in the mobile terminal 8 is set as the printing target.

<Step S208>

When the data of the printing target is the data in the mobile terminal 8, the mobile terminal 8 selects the data of the printing target in accordance with operation performed on its own operation portion. Further, the mobile terminal 8 transmits the selected data of the printing target to the reception apparatus 7 through the second communication line 92.

<Step S209>

After the processes of steps S201 to S208, the mobile terminal 8 executes the mobile-side presentation and guiding process shown in FIG. 8. A specific example of the mobile-side presentation and guiding process will be described later. After the mobile-side presentation and guiding process, the apparatus-use requesting process by the mobile terminal 8 ends.

[The Job Preparation Process]

Next, with reference to the flow chart shown in FIG. 6, one example of the procedure of the job preparation process executed by the image processing apparatus 10 will be described. In the following description, S301, S302, . . . each represents an identification character of its corresponding step executed by the image processing apparatus 10.

By the MPU 11 of the main control portion 1 in the image processing apparatus 10 executing a job preparation program Pr21, the job preparation process by the image processing apparatus 10 is realized. The main control portion 1 of the image processing apparatus 10 starts the job preparation process when being activated upon start of energization.

<Step S301>

In the job preparation process, the main control portion 1 monitors the reception status of the provided-function request command D21 from the reception apparatus 7 through the first communication line 91, and receives the provided-function request command D21 in response to a request for reception thereof. When having received the provided-function request command D21, the main control portion 1 transmits provided-function information D22 indicating the provided-function of the image processing apparatus 10, to the reception apparatus 7 through the first communication line 91.

<Step S302>

The main control portion 1 monitors the reception status of the terminal ID (D01) from the reception apparatus 7 through the first communication line 91, and receives the terminal ID (D01) in response to a request for reception thereof. Further, the main control portion 1 stores the received terminal ID (D01) in the storage portion 12.

<Step S303>

Further, the main control portion 1 stores, in the storage portion 12, information indicating restriction of execution of the image processing job, in association with the received terminal ID (D01). For example, the main control portion 1 sets to OFF a job execution permission flag indicating permission of execution of the image processing job, and stores the job execution permission flag in the storage portion 12, in association with the terminal ID (D01).

<Step S304>

Further, the main control portion 1 monitors the reception status of the printing job data D23 from the reception apparatus 7 through the first communication line 91, and receives the printing job data D23 along with the terminal ID (D01) in response to a request for reception thereof. Further, the main control portion 1 stores in the storage portion 12 the received printing job data D23, in association with the terminal ID (D01) which has been already stored.

Through the execution of the job preparation process, the image processing apparatus 10 enters a state where the image processing apparatus 10 can be used by the user carrying the mobile terminal 8 that has transmitted the job request command D11 to the reception apparatus 7.

[The Guide/Job Control]

Next, with reference to the flow chart shown in FIG. 7, one example of the procedure of the guide/job control executed by the image processing apparatus 10 will be described. In the following description, S401, S402, . . . each represents an identification character of its corresponding step executed by the image processing apparatus 10.

By the MPU 11 of the main control portion 1 in the image processing apparatus 10 executing a guide/job control program Pr22, the guide/job control by the image processing apparatus 10 is realized. The main control portion 1 of the image processing apparatus 10 starts the guide/job control when having received the terminal ID (D01) from the reception apparatus 7 in step S302 of the job preparation process, when being activated in a state where the terminal ID (D01) received from the reception apparatus 7 has been stored in the storage portion 12, or the like.

<Step S401>

In the guide/job control, the main control portion 1 monitors the reception status of the terminal ID (D01) from the mobile terminal 8 through the second communication line 92, and receives the terminal ID (D01) in response to a request for reception thereof. When having received the terminal ID (D01) from the mobile terminal 8, the main control portion 1 executes the processes from step S402 and thereafter, and when not having received the terminal ID (D01) from the mobile terminal 8, the main control portion 1 waits until receiving the terminal ID (DO 1).

<Step S402>

The main control portion 1 executes a terminal ID checking process of determining whether the terminal ID (D01) received through the second communication line 92 matches any one of terminal IDs (D01) already stored in the storage portion 12. The terminal ID checking process is a process of determining whether a state has been established where the terminal ID (DO 1) received from the reception apparatus 7 and the terminal ID (D01) received from the mobile terminal 8 match each other.

The state where the terminal ID checking process has succeeded is a state where the user carrying the mobile terminal 8 which has transmitted the job request command D11 to the reception apparatus 7 is in proximity to the image processing apparatus 10. Hereinafter, this state will be referred to as a user-in-proximity state. The state where the terminal ID checking process has succeeded is the user-in-proximity state.

In the following description, the terminal ID (D01) used in the terminal ID checking process that has succeeded, i.e., the terminal ID (D01) received from the reception apparatus 7 that matches the terminal ID (D01) received from the mobile terminal 8, will be referred to as a proximity terminal ID.

When the terminal ID checking process has failed, the main control portion 1 waits until receiving a new terminal ID (D01) by executing the processes from step S401.

<Step S403>

When the terminal ID checking process has succeeded, the main control portion 1 turns on the guide light 20. The process of turning on the guide light 20 is one example of a process of making notification through the notification portion included in the image processing apparatus 10.

<Step S404>

When the terminal ID checking process has succeeded, the main control portion 1 transmits guiding information D31 set in advance, to the mobile terminal 8 being the transmission source of the proximity terminal ID, through the second communication line 92.

The processes of step S403 and step S404 are one example of the guiding process of guiding the user to the image processing apparatus 10 when the user-in-proximity state has been established.

For example, it is conceivable that the guiding information D31 includes one or both of an apparatus periphery image and explanatory text which indicate the state of the apparatus-to-be-used and its periphery. It is also conceivable that the guiding information D31 includes azimuth information indicating the azimuth on the apparatus periphery image.

<Step S405>

In the user-in-proximity state, the main control portion 1 determines whether a predetermined arrival condition is satisfied. One example of the arrival condition is receiving a predetermined arrival response D32 from the transmission source of the proximity terminal ID before a predetermined monitoring time period elapses after the success of the terminal ID checking process.

Another example of the arrival condition is having detected a predetermined operation performed on the operation display portion 2 of the image processing apparatus 10 before the monitoring time period elapses after the success of the terminal ID checking process, in a state where the image processing apparatus 10 can communicate with the transmission source of the proximity terminal ID through the second communication line 92.

<Step S406>

When the arrival condition has been satisfied, the main control portion 1 turns off the guide light 20 and sets to ON the job execution permission flag that corresponds to the proximity terminal ID. Accordingly, with respect to the user of the transmission source of the proximity terminal ID, restriction of execution of the image processing job is canceled.

It is also conceivable that when the terminal ID checking process has succeeded, the main control portion 1 cancels restriction of execution of the image processing job with respect to the user of the transmission source of the proximity terminal ID.

<Step S407>

In the case where the printing job data D23 that corresponds to the proximity terminal ID is stored in the storage portion 12, the main control portion 1 causes the image processing portion 5 and the printing job processing portion 4 to execute the received data printing job based on that printing job data D23. Accordingly, the image processing portion 5 converts the printing job data D23 to printing image data, and the printing job processing portion 4 forms an image indicated by the printing image data, on a sheet material.

In the present embodiment, in the case where the terminal ID checking process has succeeded and the arrival condition has been satisfied, the image processing apparatus 10 executes the received data printing job based on the printing job data D23 received from the reception apparatus 7.

However, it is also conceivable that, when the terminal ID checking process has succeeded, the image processing apparatus 10 executes the received data printing job based on the printing job data D23 received from the reception apparatus 7.

<Step S408>

In the case where the arrival condition has been satisfied and then the image processing job has been designated through operation performed on the operation display portion 2, the main control portion 1 causes the document sheet scanning job processing portion 3, the printing job processing portion 4, or the like to execute the image processing job such as the designated document sheet scanning job, copying job, or the like.

<Step S409>

The main control portion 1 executes at appropriate timings a process of determining whether a predetermined ending condition is satisfied after the arrival condition has been satisfied. The main control portion 1 keeps a state where the process of step S408 can be executed in accordance with operation performed on the operation display portion 2, until the ending condition is satisfied.

One example of the ending condition is being unable to receive a continuation notification D33 including the proximity terminal ID from the mobile terminal 8 within a predetermined time period. Another example of the ending condition is having detected a predetermined ending operation performed on the operation display portion 2.

<Step S410>

When the ending condition has been satisfied, the main control portion 1 deletes the proximity terminal ID from the storage portion 12. Then, the main control portion 1 repeats the processes from step S401.

[The Mobile-Side Presentation and Guiding Process]

Next, with reference to the flow chart shown in FIG. 8, one example of the procedure of the mobile-side presentation and guiding process executed by the mobile terminal 8 will be described. In the following description, S501, S502, . . . each represents an identification character of its corresponding step executed by the mobile terminal 8.

In the mobile terminal 8, the CPU executes a presentation and guiding program stored in the storage portion. Accordingly, the mobile-side presentation and guiding process by the mobile terminal 8 is realized. The mobile-side presentation and guiding process is the process of step S209 in the apparatus-use requesting process shown in FIG. 5. That is, the mobile terminal 8 executes the mobile-side presentation and guiding process after having received the location presentation information D14 from the reception apparatus 7.

<Step S501>

In the mobile-side presentation and guiding process, the mobile terminal 8 displays the location presentation information D14 on its own display portion. For example, the mobile terminal 8 displays a route presentation screen g1 including the location presentation information D14 on the display portion.

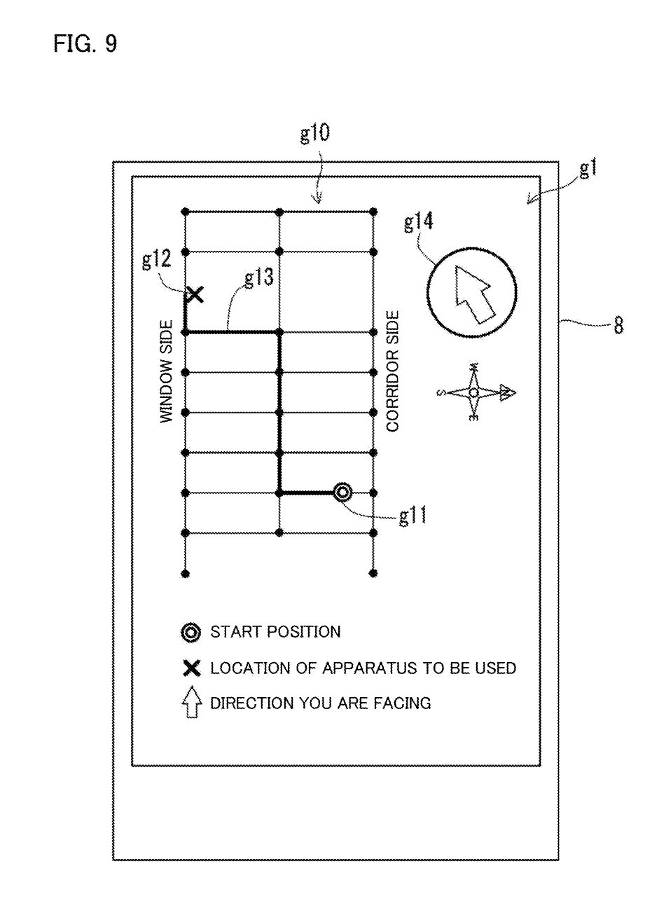

FIG. 9 shows one example of the route presentation screen g1. The route presentation screen g1 is a screen on which a floor map image g10 included in the location presentation information D14 is displayed. The floor map image g10 is an image of the floor map of the area encompassing the reception apparatus 7 and the apparatus-to-be-used.

The floor map image g10 includes a start position image g11 indicating the location of the reception apparatus 7, a destination position image g12 indicating the location of the apparatus-to-be-used, and a travel route image g13. The travel route image g13 indicates the travel route from the reception apparatus 7 to the apparatus-to-be-used.

Further, the route presentation screen g1 includes a terminal orientation image g14 indicating the orientation of the mobile terminal 8 based on the azimuth in the floor map image g10. The terminal orientation image g14 indicates the orientation of the mobile terminal 8 realized when the azimuth detected by the electromagnetic compass of the mobile terminal 8 is aligned with the azimuth indicated by the azimuth information included in the location presentation information D14.

Since the location presentation information D14 includes the azimuth information, it is possible to display the terminal orientation image g14 on the mobile terminal 8. This facilitates understanding of the relationship between the orientation of the user and the orientations of the travel route image g13 and the floor map image g10 on the route presentation screen g1. As a result, it is possible to appropriately guide the user to the apparatus-to-be-used.

It is also conceivable that the mobile terminal 8 has a function of displaying the current location thereof in the floor map image g10. For example, in the case where a plurality of wireless access points are provided in the area where the image processing system 100 is installed, the mobile terminal 8 performs location confirming communication with wireless access points that have become communicable through the second communication line 92.

In the location confirming communication, each of the wireless access points transmits, to the mobile terminal 8, access point location information indicating the location of the wireless access point in the floor map image g10, and reception intensity of radio wave transmitted from the mobile terminal 8. The mobile terminal 8 derives the current location based on a plurality of pieces of access point location information and a plurality of reception intensities, and displays the current location in the floor map image g10.

<Step S502>

While the route presentation screen g1 is displayed, the mobile terminal 8 confirms at appropriate timings whether the mobile terminal 8 can communicate with the image processing apparatus 10 in the surrounding area through the second communication line 92. Further, the mobile terminal 8 transmits its own terminal ID (D01) to the communicable image processing apparatus10 in the surrounding area, through the second communication line 92.

<Step S503>

The mobile terminal 8 monitors whether guiding information D31 arrives from the image processing apparatus 10 to which the terminal ID (D01) has been transmitted. When guiding information D31 has arrived, the mobile terminal 8 receives the guiding information D31 through the second communication line 92.

The mobile terminal 8 repeats the processes of steps S501 to S503 until receiving the guiding information D31.

<Step S504>

Next, the mobile terminal 8 displays the guiding information D31 on its own display portion. For example, the mobile terminal 8 displays a guiding screen g2 including the guiding information D31 on the display portion.

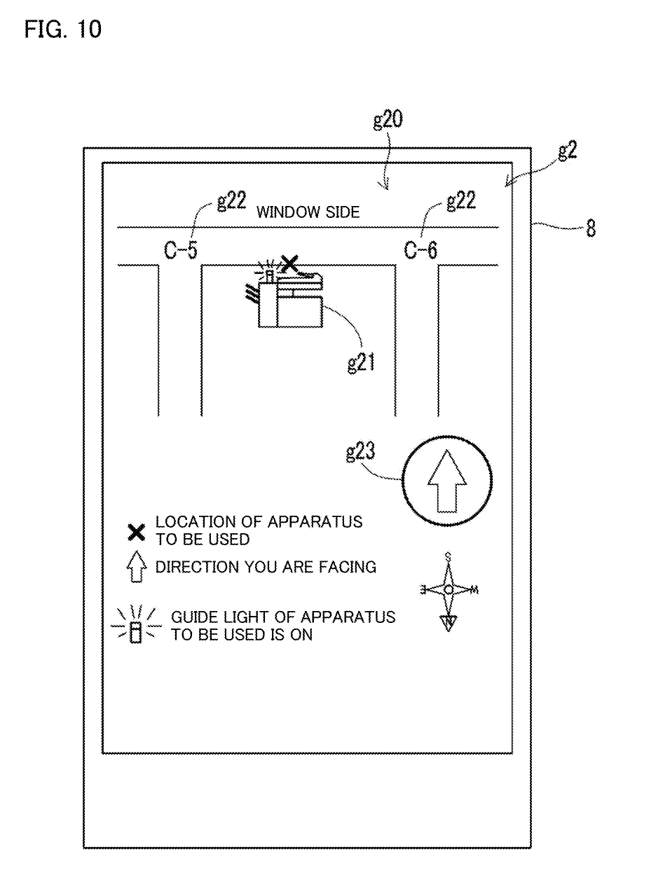

FIG. 10 shows one example of the guiding screen g2. The guiding screen g2 is a screen on which an apparatus periphery image g20 included in the guiding information D31 is displayed. The apparatus periphery image g20 includes a destination position image g21 indicating the location of the apparatus-to-be-used, and a peripheral object image g22 indicating objects located in the periphery of the apparatus-to-be-used. The peripheral object image g22 shown in FIG. 10 is an image of symbols on a route.

Further, the guiding screen g2 includes a terminal orientation image g23 indicating the orientation of the mobile terminal 8 based on the azimuth in the apparatus periphery image g20. The direction indicated by the terminal orientation image g23 is derived based on the azimuth detected by the electromagnetic compass of the mobile terminal 8 and based on the azimuth information included in the guiding information D31, similarly to the terminal orientation image g14 shown in FIG. 9.

<Step S505>

While the guiding screen g2 is displayed, the mobile terminal 8 monitors whether a predetermined confirmation operation is performed on the operation portion of the mobile terminal 8. The mobile terminal 8 repeats the process of step S504 until detecting that the confirmation operation is performed. The confirmation operation is operation for clearly showing that the user has arrived at the apparatus-to-be-used.

<Step S506>

When having detected that the confirmation operation had been performed, the mobile terminal 8 transmits a predetermined arrival response D32 to the apparatus-to-be-used through the second communication line 92. As described above, the image processing apparatus 10 in the present embodiment uses reception of the arrival response D32 as the arrival condition (S405 in FIG. 7).

After step S507, the user operates the apparatus-to-be-used and causes the apparatus-to-be-used to execute the image processing job (S408).

<Step S507>

Next, the mobile terminal 8 monitors whether a predetermined ending operation is performed on its own operation portion. The ending operation is operation for clearly showing that the user has ended using the apparatus-to-be-used. Upon detection of the ending operation, the mobile terminal 8 ends the mobile-side presentation and guiding process.

<Step S508>

Until the ending operation is detected after the arrival response D32 has been transmitted, the mobile terminal 8 transmits at appropriate timings the continuation notification D33 including its own terminal ID (D01) to the apparatus-to-be-used through the second communication line 92. The mobile terminal 8 transmits the continuation notification D33 in a predetermined cycle. Accordingly, the apparatus-to-be-used keeps the state where the apparatus-to-be-used can be used by the user (S409 in FIG. 7).

In the image processing apparatus 10, step S302 in FIG. 6 is one example of the step in which the apparatus-to-be-used receives the terminal identification information identifying the mobile terminal 8 from the reception apparatus 7. Further, the main control portion 1 executing the process of step S302 is one example of a terminal information indirect reception portion.

Step S401 in FIG. 7 is one example of the step in which the image processing apparatus 10 receives the terminal identification information from the mobile terminal 8 through the second communication line 92. Further, the main control portion 1 executing the process of step S401 is one example of an output-side terminal information direct reception portion.

Step S402 in FIG. 7 is one example of the step in which the image processing apparatus 10 determines whether the user-in-proximity state has been established where the terminal identification information received from the reception apparatus 7 and the terminal identification information received from the mobile terminal 8 match each other. Further, the main control portion 1 executing the process of step S402 is one example of an information matching determination portion.

Steps S403 and S404 in FIG. 7 are one example of the step in which the image processing apparatus 10 executes the guiding process of guiding the user to the image processing apparatus 10 when the user-in-proximity state has been established. Further, the main control portion 1 executing the processes of steps S403 and S404 are one example of a user guiding potion.

Step S303 in FIG. 6 and steps S401 to S406 in FIG. 7 are one example of the step in which the image processing apparatus 10 restricts execution of the image processing job by the job execution portion until a result of the determination that the user-in-proximity state has been established is obtained. Further, the main control portion 1 executing the processes of step S303 and steps S401 to S406 is one example of a job restriction portion. The document sheet scanning job processing portion 3 and the printing job processing portion 4 are one example of the job execution portion. The printing job the execution of which is restricted includes the received data printing job that corresponds to the printing job data D23 received from the transmission source of the terminal identification information.

Step S301 in FIG. 6 is one example of the step in which each image processing apparatus 10 transmits, to the reception apparatus 7, information of the provided-function being the image processing function provided in the image processing apparatus 10. Further, step S102 in FIG. 4 is one example of the step where the reception apparatus 7 receives the information of the provided-function.

Steps S102 to S105 in FIG. 4 is one example of the step in which the reception apparatus 7 selects the apparatus-to-be-used from among a plurality of image processing apparatuses 10 that are communicable through the first communication line 91. Further, the CPU 711 of the reception apparatus 7 executing the processes of steps S102 to S105 is one example of an apparatus-to-be-used selection portion.

Step S101 in FIG. 4 is one example of the step in which the reception apparatus 7 receives the terminal identification information identifying the mobile terminal 8, from the mobile terminal 8 through the wireless second communication line 92. Further, the CPU 711 of the reception apparatus 7 executing the process of step S101 is one example of an input-side terminal information direct reception portion.

Step S106 in FIG. 4 is one example of the step in which the reception apparatus 7 transmits the location presentation information D14 regarding presentation of the location of the apparatus-to-be-used, to the mobile terminal 8 through the second communication line 92. Further, the CPU 711 executing the process of step S106 is one example of a location presentation information transmission portion.

Step S107 in FIG. 4 is one example of the step in which the reception apparatus 7 transmits the terminal identification information to the apparatus-to-be-used through the first communication line 91. Further, the CPU 711 executing the process of step S107 is one example of a terminal information transmission portion.

Step S101 and step S110 in FIG. 4 are one example of the step in which the reception apparatus 7 receives a request for the printing job from the mobile terminal 8 through the second communication line 92.

Step S112 in FIG. 4 is one example of the step in which the reception apparatus 7 transmits the printing job data D23 to be used in the printing job, to the apparatus-to-be-used through the first communication line 91. Step S304 in FIG. 6 that corresponds to this is one example of the step in which the apparatus-to-be-used receives the printing job data D23.

Step S101 in FIG. 4 is one example of the step in which the reception apparatus 7 receives the requested-function information D02 being the image processing function requested by the user, from the mobile terminal 8 through the second communication line 92.

Step S103 in FIG. 4 is one example of the step in which the reception apparatus 7 specifies the transmission sources of information of the provided-function encompassing the requested-function, as the selection candidates D12 for the apparatus-to-be-used. In step S105, the reception apparatus 7 selects the apparatus-to-be-used from among the selection candidates D12.

In the image processing system 100, the reception apparatus 7 which is the information processing apparatus receiving a request for the image processing job, and the image processing apparatus 10 transmit the location presentation information D14 and the guiding information D31 to the mobile terminal 8 of the user. Accordingly, it becomes possible to appropriately guide the user to an image processing apparatus that can execute the image processing job requested by the user. This is preferable in a use environment where the user does not know the location and the like of each of the plurality of image processing apparatuses 10.

Execution of the received data printing job requested by the user is suspended until the state is established where the mobile terminal 8 of the user comes close to the apparatus-to-be-used (S303 in FIG. 6, S406 in FIG. 7). Accordingly, it is possible to prevent the printed matter of the user from being viewed or taken away by another person.

The reception apparatus 7 specifies transmission sources of information of the provided-function encompassing the requested-function, as the selection candidates D12 for the apparatus-to-be-used, and selects the apparatus-to-be-used from among the selection candidates D12 (S102 to S105 in FIG. 4). Accordingly, even when the user does not know the function of each image processing apparatus 10, an image processing apparatus 10 that can execute the image processing job requested by the user is selected as the apparatus-to-be-used.

The image processing apparatus 10 executes, as the guiding process, the process of making notification through the guide light 20 provided in the image processing apparatus 10 (S403 in FIG. 7). Further, the image processing apparatus 10 executes, as the guiding process, the process of transmitting the guiding information D31 to the mobile terminal 8 (S404 in FIG. 7). Accordingly, the user is guided to the apparatus-to-be-used in a state where the apparatus-to-be-used is more easily recognized.

### Application Example

It is conceivable that, in the image processing system 100, the reception apparatus 7 transmits the URL of a Web page that includes an image, text, or the like that presents the location of the apparatus-to-be-used, as the location presentation information D14 to the mobile terminal 8. Similarly, it is also conceivable that the image processing apparatus 10 transmits the URL of a Web page that includes an image, text, or the like that guides the user to the image processing apparatus 10, as the guiding information D31 to the mobile terminal 8.

It is also conceivable that, in the image processing system 100, before the reception apparatus 7 receives the job request command D11 from the mobile terminal 8, the reception apparatus 7 executes in advance the process of step S102 of receiving the provided-function information D22 from each image processing apparatus 10.

It is also conceivable that, in the image processing system 100, each image processing apparatus 10 also serves as the reception apparatus 7. In this case, it is sufficient that the mobile terminal 8 of the user transmits the job request command D11 to the nearest image processing apparatus 10. Accordingly, an image processing apparatus 10 that has the requested-function and that is selected from among a plurality of image processing apparatuses 10 including the nearest image processing apparatus 10 is presented as the apparatus-to-be-used.

It is also conceivable that the image processing apparatus 10 includes, as the notification portion, an audio device that outputs a notification sound, instead of or in addition to the guide light 20.

The image processing apparatus presentation method, the image processing apparatus, and the image processing system according to the present disclosure can also be configured by freely combining the embodiments and the application example described above, or by omitting a part of or modifying the embodiments and the application example as appropriate, within the scope of the invention defined by claims.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus presentation method comprising:
a first information processing apparatus selecting an apparatus-to-be-used from among a plurality of image processing apparatuses that are communicable through a first communication line;
the first information processing apparatus receiving terminal identification information which identifies a second information processing apparatus carried by a user, from the second information processing apparatus through a wireless second communication line;
the first information processing apparatus transmitting location presentation information regarding presentation of a location of the apparatus-to-be-used, to the second information processing apparatus through the second communication line;
the first information processing apparatus transmitting the terminal identification information to the apparatus-to-be-used through the first communication line, and the apparatus-to-be-used receiving the terminal identification information from the first information processing apparatus;
an image processing apparatus receiving the terminal identification information from the second information processing apparatus through the second communication line;
the image processing apparatus determining whether a user-in-proximity state has been established where the terminal identification information received from the first information processing apparatus and the terminal identification information received from the second information processing apparatus match each other; and
the image processing apparatus executing a guiding process of guiding the user to the image processing apparatus when the user-in-proximity state has been established.

2. The image processing apparatus presentation method according to claim 1, further comprising
the image processing apparatus restricting execution of an image processing job including a printing job of forming an image on a sheet material or a document sheet scanning job of reading an image from a document sheet, until the user-in-proximity state has been established at least.

3. The image processing apparatus presentation method according to claim 2, further comprising:
the first information processing apparatus receiving a request for the printing job from the second information processing apparatus through the second communication line;
the first information processing apparatus transmitting printing job data to be used in the printing job to the apparatus-to-be-used through the first communication line, and the apparatus-to-be-used receiving the printing job data; and
the image processing apparatus restricting execution of the printing job in accordance with the printing job data received from a transmission source of the terminal identification information, until the user-in-proximity state has been established at least.

4. The image processing apparatus presentation method according to claim 1, further comprising:
each of the image processing apparatuses transmitting, to the first information processing apparatus, information of a provided-function which is an image processing function provided in the image processing apparatus, and the first information processing apparatus receiving the information of the provided-function;
the first information processing apparatus receiving, from the second information processing apparatus through the second communication line, information of a requested-function which is an image processing function requested by the user; and
the first information processing apparatus specifying, as a selection candidate for the apparatus-to-be-used, each transmission source of the information of the provided-function encompassing the requested-function, wherein
the first information processing apparatus selects the apparatus-to-be-used from among the selection candidates.

5. The image processing apparatus presentation method according to claim 1, wherein
the guiding process includes one or both of a process of making notification through a notification portion provided in the image processing apparatus, and a process of transmitting guiding information through the second communication line to the second information processing apparatus that is a transmission source of the terminal identification information.

6. An image processing apparatus comprising:
a first communication portion communicable with a first information processing apparatus through a first communication line;
a second communication portion communicable with a second information processing apparatus carried by a user, through a wireless second communication line;
a job execution portion configured to execute an image processing job including a printing job of forming an image on a sheet material or a document sheet scanning job of reading an image from a document sheet;
a terminal information indirect reception portion configured to receive terminal identification information which identifies the second information processing apparatus, from the first information processing apparatus through the first communication line;
an output-side terminal information direct reception portion configured to receive the terminal identification information from the second information processing apparatus through the second communication line;
an information matching determination portion configured to determine whether a user-in-proximity state has been established where the terminal identification information received from the first information processing apparatus and the terminal identification information received from the second information processing apparatus match each other; and
a user guiding potion configured to execute a guiding process of guiding the user to the image processing apparatus when the user-in-proximity state has been established.

7. The image processing apparatus according to claim 6, further comprising
a job restriction portion configured to restrict execution of the image processing job to be performed by the job execution portion until a result of the determination that the user-in-proximity state has been established is obtained.

8. The image processing apparatus according to claim 6, wherein
the guiding process includes one or both of a process of making notification through a notification portion provided in the image processing apparatus, and a process of transmitting guiding information through the second communication line to the second information processing apparatus that is a transmission source of the terminal identification information.

9. An image processing system comprising:
a plurality of the image processing apparatuses according to claim 6; and
a first information processing apparatus communicable with each of the image processing apparatuses through a first communication line, wherein
the first information processing apparatus includes:
an apparatus-to-be-used selection portion configured to select an apparatus-to-be-used from among the plurality of the image processing apparatuses;
an input-side terminal information direct reception portion configured to receive terminal identification information which identifies a second information processing apparatus carried by a user, from the second information processing apparatus through a wireless second communication line;
a location presentation information transmission portion configured to transmit location presentation information regarding presentation of a location of the apparatus-to-be-used, to the second information processing apparatus through the second communication line; and
a terminal information transmission portion configured to transmit the terminal identification information to the apparatus-to-be-used through the first communication line.
